(19) United States
(12) Patent Application Publication
(10) Pub. No.: US 2025/0008964 A1
(43) Pub. Date: Jan. 9, 2025

(54) OVEN VENTILATION FOR CONVECTIVE COOKING AND DRYING OF FOOD

(71) Applicant: JOHN BEAN TECHNOLOGIES CORPORATION, Chicago, IL (US)

(72) Inventors: Owen Eugene MOREY, Huron, OH (US); Ramesh M. GUNAWARDENA, Solon, OH (US); Andrew A. JOHNSON, Newaygo, MI (US); Scott E. STANG, Monroeville, OH (US)

(73) Assignee: JOHN BEAN TECHNOLOGIES CORPORATION, Chicago, IL (US)

(21) Appl. No.: 18/554,304

(22) PCT Filed: Apr. 21, 2022
(86) PCT No.: PCT/US2022/025695

§ 371 Date: Oct. 6, 2023

Related U.S. Application Data
(60) Provisional application No. 63/177,658, filed on Apr. 21, 2021.

(51) Int. Cl. A21B 1/48; A21B 3/04; F26B 3/04; F26B 15/26; F26B 21/08; F26B 21/10; F26B 21/12

(52) U.S. Cl. CPC A21B 1/48; A21B 3/04; F26B 3/04; F26B 15/26; F26B 21/08; F26B 21/10; F26B 21/12

(57) ABSTRACT

Systems and methods directed to oven ventilation for convective cooking and drying of food are presented herein. In one embodiment, a thermal processing apparatus includes: a housing and a powered conveyor belt configured for supporting work products during thermal processing. The conveyor belt is moving along a spiral path arranged as a tiered stack. A recirculation system is configured for directing a thermal processing medium through the tiers of the spiral conveyor in a recirculating flow. An exhaust vent has an inlet proximate to an area of a high moisture content inside the housing. The exhaust vent is configured for exfiltrating the thermal processing medium having the high moisture content. An opening is configured for infiltrating the thermal processing medium from outside of the housing.

### CROSS-REFERENCE TO RELATED APPLICATION

This international patent application claims priority to U.S. Provisional Application No. 63/177,658, filed on Apr. 21, 2021, the entire disclosure of which is hereby incorporated by reference herein for all purposes.

### BACKGROUND

Spiral conveyor-based thermal processing systems include heating surface or a cooling/freezing surface in the form of a pervious conveyor belt for conveying work pieces, including food, through a thermal processing chamber in a spiral or helical path. Analogously, linear conveyors may be used for conveying work pieces (work products). If the work piece is being cooked or otherwise heated, the heat source, such as steam, heated air or mixtures thereof, is provided within or adjacent the cooking chamber for heating the work pieces. For the work piece that is being heated and dried, thermal processing medium may be air. Correspondingly, if thermal processing includes cooling or freezing, then the source of cooling medium is provided either within the cooling/freezing chamber or adjacent thereto.

An advantage of thermal processing systems utilizing spiral conveyor belts is that a relatively long processing path may be achieved with a small footprint. For example, a 600 feet long thermal processing conveyor belt in a spiral configuration can be contained within about a 20 ft×20 ft×20 ft housing. However, spiral stack conveyor thermal processing systems have some inherent drawbacks from a linear oven or freezer of a comparable length. In a linear oven or freezer, the upper and lower surfaces are exposed to highly efficient flow impinged upon by the thermal processing medium. However, in a spiral oven, the work products are not as directly accessible to the thermal processing medium since the work products are arranged in stacked layers, thus requiring a less direct thermal processing method.

In some spiral stack conveyor configurations, a fan system is used to direct the flow of thermal processing medium in the form of 100% steam or air or a mixture of steam and air horizontally across the layers of the spiral stack. A fan system is used to draw the processing medium across the stack and then typically up to a location above the spiral stack and through a heat exchanger to either heat or cool the treating medium. After exiting the heat exchanger, the treated medium is directed to flow downwardly along an exterior portion of the stack diametrically opposite to the location of the circulating fans to draw the heating medium laterally into the spiral stack and then across the spiral stack.

As will be appreciated, this flow arrangement results in poor control of the properties of the heating medium as the heating medium flows over the work pieces inside the spiral stack conveyor. For example, the thermal treating medium may not achieve uniform treatment of all the work products positioned across the width of the helically arranged conveyor because of differences in temperature, humidity content or velocity of the air flow over the work pieces. This is especially true for the work products that are to be dried, especially since such work products may release significant moisture that saturates the treating medium (e.g., air), in turn making both heat and mass transfer less efficient or at least less predictable. Various attempts have been made to address this situation, but typically without full success. Accordingly, systems and methods are needed for improved thermal processing of food work pieces.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a thermal processing apparatus includes: a housing, and a powered conveyor belt configured for supporting work products during thermal processing. The conveyor belt moves along a spiral path arranged as a tiered stack. A recirculation system is configured for directing a thermal processing medium through the tiers of the spiral conveyor in a recirculating flow. An exhaust vent has an inlet proximate to an area of a high moisture content inside the housing. The exhaust vent is configured for exfiltrating the thermal processing medium having the high moisture content. An opening is configured for infiltrating the thermal processing medium from outside of the housing.

In one aspect, the work products are subjected to drying.

In another aspect, the recirculation system includes one or more fans configured to flow the thermal processing medium.

In one aspect, the system also includes an exhaust air mover configured for exfiltrating the thermal processing medium through the exhaust vent.

In one aspect, the system also includes: at least one sensor selected from a group consisting of a temperature sensor, a humidity sensor, a pressure sensor, and a velocity sensor; and a controller having an input operatively coupled with the at least one sensor, and having an output operatively coupled with the exhaust air mover. The controller is configured to regulate operation of the exhaust air mover based on the input received from the at least one sensor.

In one aspect, the opening is equipped with an intake valve for regulating an infiltration of the thermal processing medium from outside of the housing, and the controller is configured to regulate opening and closing of the intake valve.

In one aspect, the system also includes an exhaust valve configured within the exhaust vent. The controller is configured for regulating opening and closing of the exhaust valve.

In one aspect, the system also includes a baffle configured for separating flows of the thermal processing medium inside the thermal processing apparatus.

In one aspect, the system also includes, a heat exchanger configured to add heat to the recirculating flow.

In one aspect, the system also includes a plenum configured to direct the recirculating flow toward the heat exchanger.

In one embodiment, a method for thermally processing work products includes moving a powered conveyor belt along a spiral path arranged as a tiered stack inside a thermal processing apparatus. The conveyor belt is configured for supporting the work products during thermal processing. The method also includes: flowing a thermal processing medium as a recirculating flow through tiers of a spiral conveyor inside a housing: exfiltrating the thermal processing medium having a high moisture content through an exhaust vent having an inlet proximate to an area of the high moisture content inside the housing; and infiltrating the thermal processing medium from outside of the housing through an opening configured in the housing.

In one aspect, the exhaust vent includes an exhaust air mover.

In another aspect, the exhaust air mover is a fan.

In one aspect, the method also includes: regulating operation of the exhaust air mover based on an input received from at least one sensor selected from a group consisting of a temperature sensor, a humidity sensor, a pressure sensor, and a velocity sensor. An input of the controller is operatively coupled with the at least one sensor, and an output is operatively coupled with the exhaust air mover. An output of the controller is operatively coupled to the exhaust air mover.

In one aspect, the opening is equipped with an intake valve for regulating an infiltration of the thermal processing medium from outside of the housing. The method further includes regulating operation of the intake valve by the controller.

In one aspect, an exhaust valve is configured within the exhaust vent. The method further includes regulating operation of the exhaust valve by the controller.

In another aspect, the exhaust valve is a butterfly valve.

In one aspect, the method also includes separating flows of the thermal processing medium inside the thermal processing apparatus by a baffle.

In one aspect, the method also includes directing the recirculating flow through a plenum configured to direct the recirculating flow toward a heat exchanger.

In one aspect, the method also includes adding heat to the recirculating flow by the heat exchanger.

In another aspect, the work products are food items.

In one aspect, the work products are subjected to drying. The method also includes controlling thermal processing medium to less than 20% moisture by volume (% MV) during operation.

In one aspect, the work products are subjected to drying. The method also includes controlling thermal processing medium to less than 5% moisture by volume (% MV) during operation.

In one aspect, the work products are subjected to drying. The method also includes controlling thermal processing medium to less than 3% moisture by volume (% MV) during operation.

In one aspect, the work products are subjected to cooking. The method also includes controlling thermal processing medium to greater than 20% moisture by volume (% MV) during operation.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial view showing dual spiral conveyor stacks according to prior art;

FIG. 2 is a pictorial view of a portion of FIG. 1 showing a single spiral conveyor stack:

FIG. 3 is a schematic cross-section view of FIG. 1 taken along lines 3-3 thereof:

FIG. 4 is a schematic diagram of air flow in an embodiment of the present disclosure:

FIG. 5A is a top view of air flow in a thermal processing apparatus of the present disclosure:

FIG. 5B is a side view of air flow shown in FIG. 5A:

FIG. 6 is an isometric view of a thermal processing apparatus of the present disclosure:

FIGS. 7A and 7B show details of the thermal processing apparatus of FIG. 6:

FIG. 8 shows controls of a thermal processing apparatus of the present disclosure; and

FIG. 9 shows a graph of moisture volume (MV) as a function of time for a thermal processing apparatus of the present disclosure.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below;” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” Such terms, unless otherwise defined, indicate up to 5% variation of the stated value. These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

The present application refers to “work product or “workpiece” synonymously. One example of a work product or workpiece described in the present application is a food product, such as for example, beef, poultry, fish, vegetable, fruit, and nuts.

In the following description and in the accompanying drawings, corresponding or similar systems, assemblies, apparatus and units may be identified by the same part number, but with an alpha suffix or with a prime or double prime designation. The descriptions of the parts/components of such systems assemblies, apparatus, and units that are the same or similar are not repeated so as to avoid redundancy in the present application.

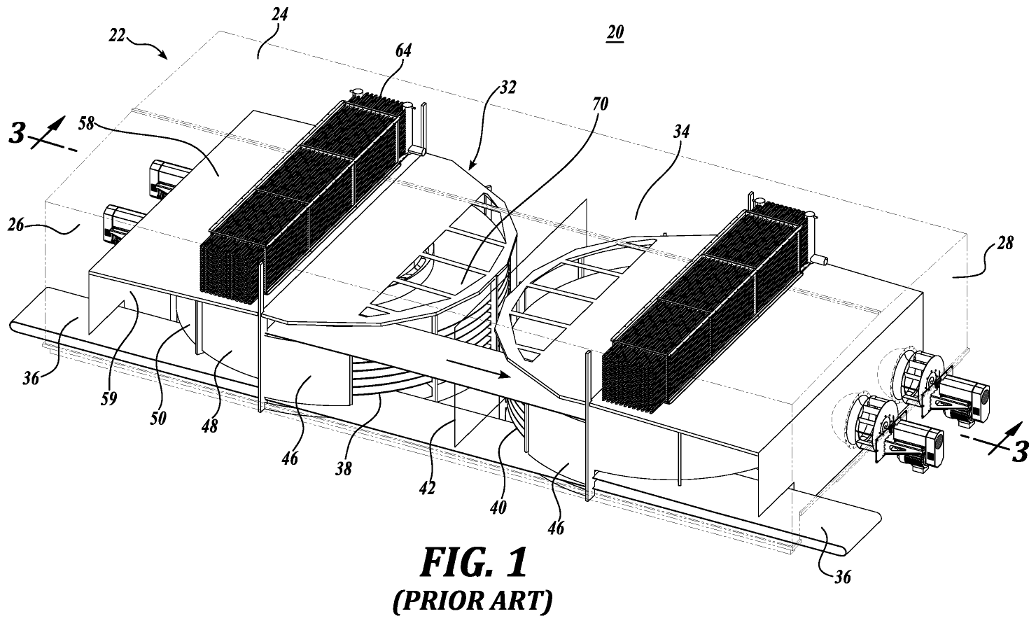

Referring initially to FIGS. 1-3, prior art thermal processing apparatus 20 is illustrated as including a generally rectangularly shaped housing 22 having a top section 24, longitudinal side sections 26, and transverse end sections 28, as well as a floor 30. The housing 22 is sized to contain first and second spiral or helical conveyor units 32 and 34. A continuous powered conveyor belt 36 is arranged in tiers forming an ascending spiral belt path (also referred to as “stack”) 38 in conveyor unit 32 and arranged in tiers forming a descending spiral belt path 40 in conveyor unit 34. As shown in FIG. 1, the conveyor belt 36 enters the spiral conveyor unit 32 at the bottom thereof at an inlet and then travels in a spiral until reaching the top of the spiral belt path 38 and then extends tangentially from spiral belt path 38 to the top spiral belt path 40 to descend along the spiral conveyor unit 34 to eventually exit the unit 34 from the bottom tier of the spiral belt path 40. While single stack spiral belts are described herein, it is to be understood that self-stacking spiral belt conveyor ovens and linear belt conveyor ovens are also encompassed by the present disclosure.

A center or mid wall 42 divides the two spiral conveyor units 32 and 34 into separate zones wherein different process media conditions can be employed. For example, the temperature of the air or other processing medium, the moisture in the air, etc., may be different in the two zones created by the mid or cross wall 42

The circumferences of the conveyor stacks 38 and 40 are partially enclosed by side panels including panels 46, 48 and 50 which are visible in the figures, as well as additional panels facing the ends 28 of the housing 22 which are not visible in the figures. However, the sections of the conveyor belt path 38 and 40 facing the cross wall 42 are substantially closed off from one another by cross wall 42 which creates separation of the process zones each having a separate environment for receiving the processing medium therein, as discussed below. The embodiment shown illustrates 2 zones separated by an internal cross wall 42, however the drying effect can be created by one or more than two zones.

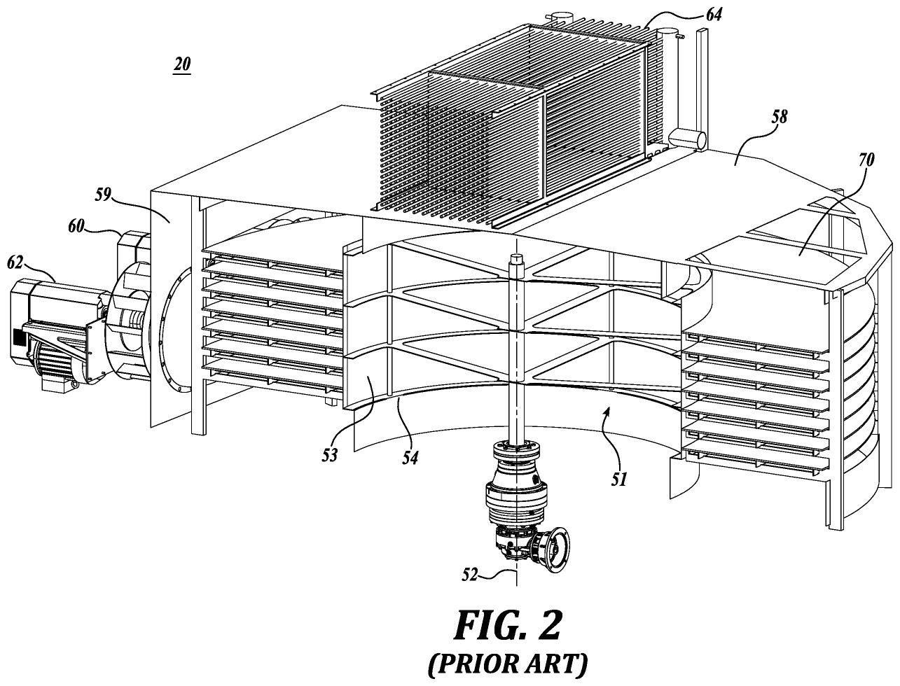

As best shown in FIG. 2, the center of the conveyor belt path 38 and 40 extend around a central drive system 51 that rotates the conveyor units 32 and 34 about a central axis 52. The drive system includes a cylindrical drive drum 53 that frictionally, rotationally drives conveyor belt 36 over supports 54 that are fixed in place, thereby to rotate the belt about axis 52. The belt 36 tightens around the drive drum 53 creating enough friction therebetween to drive the belt forward to slide over the supports 54. The drive drum 53 is carried by a frame structure radiating outward from central vertical axle 56 that extend upwardly from a power unit 57 that rotates the axle 56 about axis 52.

A ceiling or top sheet structure 58 overlies a substantial portion of the conveyor stacks 38 and 40. The ceiling structure toward the mid wall 42 may be shaped to correspond to the circular shape of the conveyor stacks 38 and 40. However, from about the center of the conveyor stacks toward the housing end walls 28, the ceiling structure 58 may be generally rectangular in shape, and once past the circumference of the stacks 38 and 40, the ceiling structure extends downwardly to form a flange section 59.

Circulation fans 60 and 62 are positioned at outward sides of the conveyor units 32 and 34 to draw processing medium, for example, air, across the interior of the conveyor belt paths 38 and 40 (around hub 53) so as to thermally treat the work products being carried on the conveyor belt 36 and then direct such processing medium upwardly along the end walls 28 of the housing 22 toward the top section 24 of the housing. Thereafter the processing medium is directed through a heat exchanger 64 extending transversely across the top of each of the belt paths 38 and 40. The heat exchanger 64 may be mounted on or just above the ceiling 58 by an appropriate mounting structure.

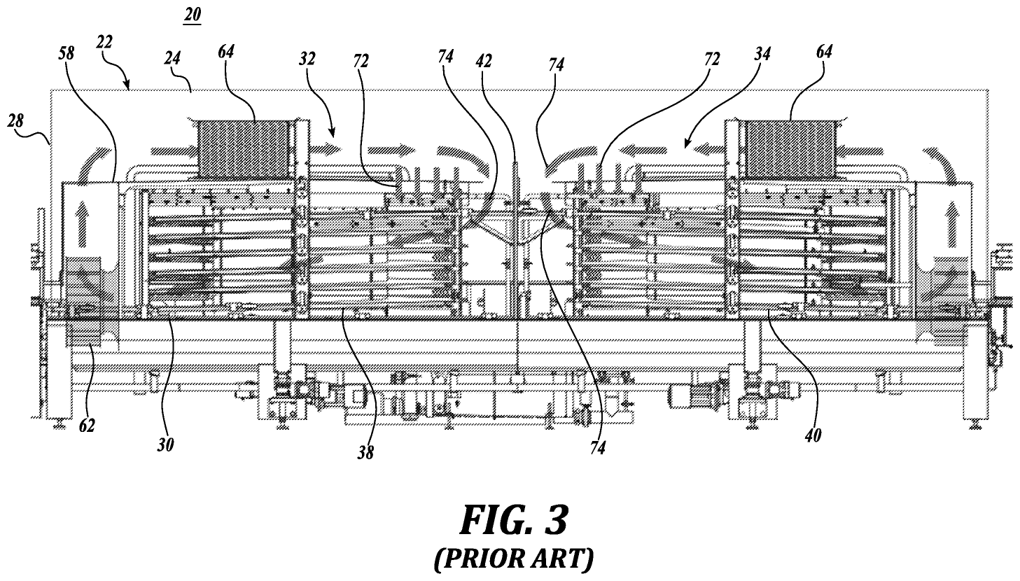

The processing air or other medium being circulated by the fans 60 and 62 when passing through the heat exchanger 40 is either cooled or heated as desired. The heated or cooled processing medium then continues to flow over the ceiling 58 until reaching a segment shaped opening 70 formed in the inward section of the ceiling (adjacent the mid or cross wall 42). Some of the processing medium, represented by arrows 72, flows downwardly through the opening 70, see FIG. 3. The remainder of the processing medium continues to flow horizontally over the ceiling 58 until reaching the cross wall 42 wherein the processing medium is deflected downwardly to flow along the exposed adjacent portion of the conveyor belt paths 38 and 40 and enter into the each of the tier space openings in a range from lateral to angled vector directions as depicted by arrows 74 in FIG. 3.

In a typical installation, the ceiling 58 would cover the entire top of the stacks 38 and 40 so that all the processing medium would be forced to flow over the top of the ceiling until reaching the cross wall 42 to then be directed downwardly and then laterally into the tiers openings of the spiral belt path shown in belt paths 38 and 40. Openings 70 in the portion of the ceiling 58 located adjacent or toward the mid wall 42 enable at least a portion of the processing medium to flow downwardly through the opening and into the tiers of the spiral conveyor stacks. As a result, more uniform thermal processing of the work product across the entire width of the conveyor belt 36 is achieved.

During the operation of these conventional ovens, some processing medium (e.g., air) leaves the housing of the thermal processing apparatus 20 through the openings that are needed for the conveyor 36 to enter/leave the apparatus. Conversely, some processing medium is drawn into the system to balance the pressure inside the thermal processing apparatus. However, such incidental leakage/intake (exfiltration/infiltration) of the processing medium is often insufficient and/or poorly balanced for an optimal operation of the thermal processing apparatus. This issue is especially significant for the food drying processing where the air humidity levels should be precisely controlled for the food drying to be effective. For example, jerky drying for extended periods in a standard operating protein oven would cause humidity to elevate uncontrollably within the chamber. The reason for such elevated humidity is that the standard oven ventilation is not adequately located, and the humidity removal rates are not controllable. In general, conventional ovens are better suited for the containment of moisture than for removing it.

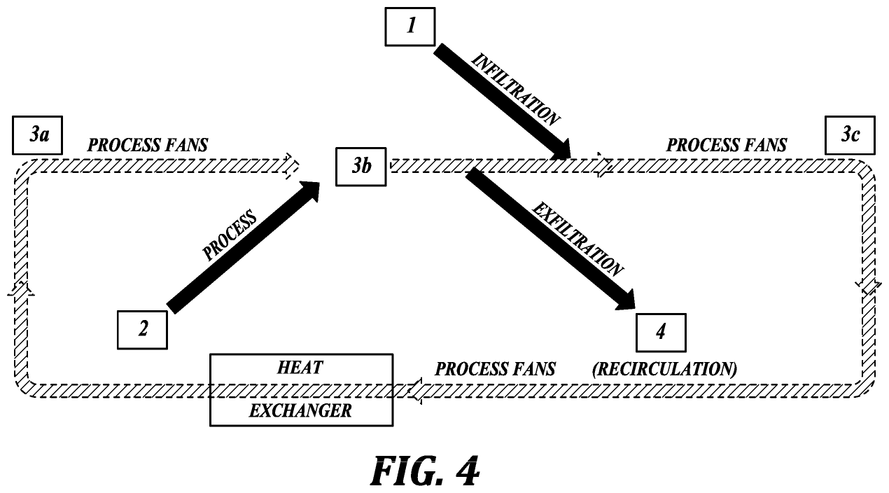

FIG. 4 is a schematic diagram of air flow in an embodiment of the present disclosure. The illustrated flow patterns represent mass flow of the processing medium (e.g., air, steam, nitrogen, combination of air and steam, etc.) that includes moisture content. Such thermal processing of the work pieces corresponds to convective cooking and drying of work pieces (also referred to as work products, food pieces, food products, or simply referred to as food for simplicity and brevity).

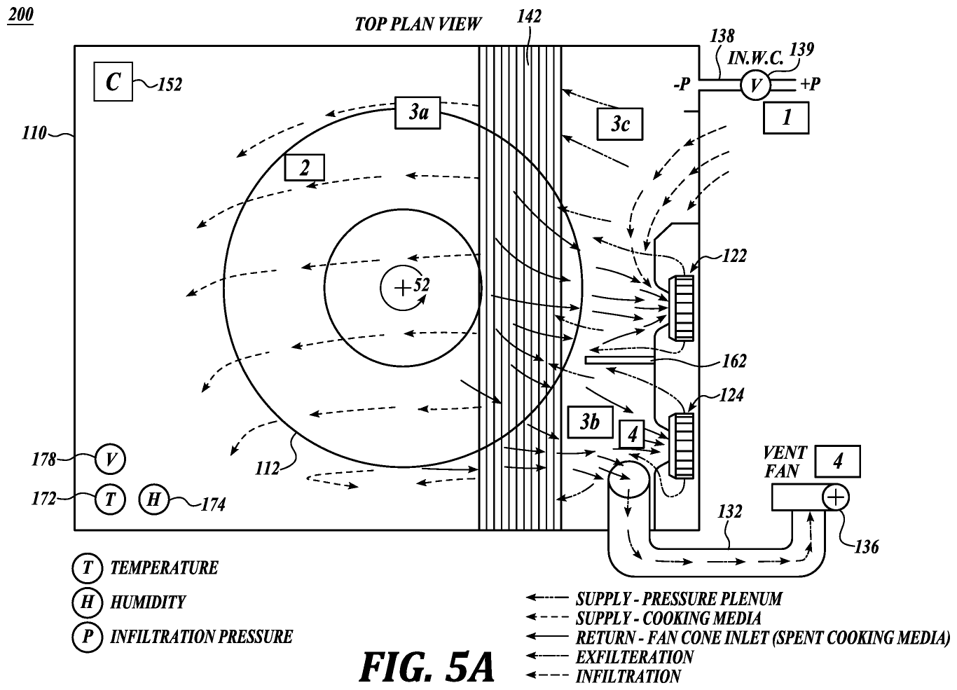

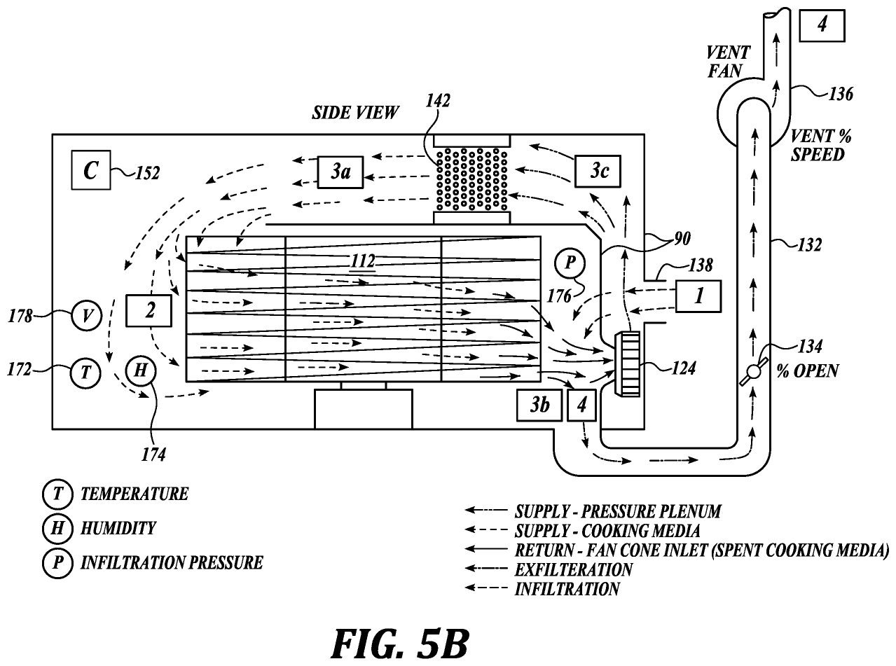

The schematic diagram includes two main flow patterns. The first flow pattern is an internal flow recirculation caused by, for example, process fans 62, 64 in FIG. 1 or by process fans 122, 124 in FIGS. 5A-5B. This flow pattern is referred to as a recirculation flow pattern, and is marked as the 3a, 3b, 3c flow in FIG. 4.

The remaining flow patterns shown in FIG. 4 are infiltration/exfiltration patterns. In particular, flow 1 indicates flow infiltration of a dry make-up air arriving from outside of the thermal processing apparatus. Such flow 1 may be characterized by a relatively low humidity. In some embodiments, the humidity of flow 1 may be about 1.6% moisture volume (MV) bringing in about 148.5 lb water vapor per minute.

Flow 4 indicates flow exfiltration through dedicated exhaust vent and exhaust air mover. In some embodiments, the exhaust air mover may flow about 3,000 cubic feet per minute (CFM) of the exhaust air at 190° F. and 14.5% MV. Such an outflow of the processing medium corresponds to evacuating about 155 lb of water vapor per minute from the thermal processing apparatus.

Flow 2 indicates a transfer of water vapor content taking place on the conveyor belt from the work products to the processing medium. In some embodiments of the drying process, the amount of water vapor transferred from the work product to the processing medium may be about 12.5 lb/minute at about 100% MV.

In operation, the recirculation flow pattern 3a, 3b, 3c may have different vapor content and temperature depending on a particular location within the thermal processing apparatus. In some embodiments, the parameter of the recirculation flow pattern 3a, 3b, 3c may range from about 225° F. and 8% MV at 3a, to about 200° F. and 14.5% MV at 3b, and then to about 190° F. and 12.9% MV at 3c. 21. In different embodiments, the work pieces that are food items may be subjected to, for example: (a) thermal processing medium to less than 20% moisture by volume (% MV) during operation: (b) thermal processing medium to less than 5% moisture by volume (% MV) during operation: (c) thermal processing medium to less than 3% moisture by volume (% MV) during operation: or (d) thermal processing medium to greater than 20% moisture by volume (% MV) during operation.

The vapor content at 3c is diluted due to the infiltration flow 1 of the outside air having a relatively low vapor content. Entering dry air (flow 1) mixes with the recirculation flow to evaporate moisture away from work pieces at least in part due to the higher concentration gradient that exits between the surfaces of the food items and the concentration of this incoming air, relative to the existing spent air. As a result, the moisture addition increases humidity of the entering dry air of flow 1. Therefore, ‘dryness’ of entering dry air (flow 1) is utilized for holding humidity at a steady state for the evaporation of moisture from the product. A person of ordinary skill would know that the process air having increased humidity may be referred to as the ‘spent’ air.

During the drying process, evaporation rate of water from work pieces has an inverse relationship with set humidity and time of drying (set time). Stated differently, decrease in evaporation rate is related to increase of set humidity. When the humidity increase is not properly controlled, the set time for same water evaporation loss becomes longer. To keep these relationships approximately constant, humidity should be controlled and excess humidity in air should be removed from the chamber to hold a constant climate (i.e., temperature and vapor content) within the apparatus. For example, exfiltration flow 4 of moist air can induce air flow 1 with drier properties to enter the chamber, therefore preventing humidity levels from elevating. In the context of this specification, the exfiltration/infiltration flows are collectively referred to as oven ventilation.

FIGS. 5A and 5B are top and side views, respectively, of air flow in an embodiment of the present disclosure. In operation, the recirculating flow 3a, 3b, 3c flows over the work products being carried on the conveyor belt of the spiral processor 112. Recirculating flow 3a, 3b, 3c is driven by air movers (e.g., fans) 122, 124. As explained above, moisture content in the recirculating flow 3a, 3b, 3c may vary along the flow path, and the moisture content generally increases as the recirculating flow stays in contact with the work products. In some embodiments, air movers 122, 124 force recirculating flow 3c through a plenum 90 toward a heat exchanger 142. The heat exchanger 142 adds heat to this recirculating flow to bring it up to the dryer operating temperature set point. The air movers 122, 124 and heat exchanger 142 may be collectively referred to as a recirculation system. In some embodiments, the recirculation system may include just one air mover or more than two air movers 122, 124. Analogously, the recirculation system may include more than one heat exchanger. Lost heat is added to the process as cooking medium passes through the heat exchanger. In many situations, controlling water vapor content of the processing medium (e.g., circulating air) is more difficult than controlling dry bulb temperature.

In some embodiments, thermal processing apparatus (e.g., a dryer) 200 includes an exhaust vent 132 (e.g., duct, pipe, etc.) and an exhaust air mover 136 (e.g., a fan) on a housing 110. Operation of the exhaust air mover 136 at least partially determines the exhaust of the saturated flow stream 4 (exfiltration flow stream). In some embodiments, exhaust vent 132 may also include a valve (e.g., a butterfly valve) 134 for additional regulation of exhausting the saturated stream 4. Generally, to minimize the flow rate of saturated flow stream 4, the exhaust vent 132 should be placed close to the highly saturated part of the recirculating flow 3b. Such optimal location generally varies for different types of the thermal processing apparatuses (e.g., dryers), and may be determined by field measurements or numerical simulations.

In some embodiments, a baffle 162 may improve separation of the flows inside the thermal processing apparatus. A baffle that is located therebetween the fan suction locations facilitate separation of the two streams before they are mixed inside a plenum 90. The plenum combines the streams of dry air infiltration stream 1 with recirculation flow to achieve the target set point humidity concentration. The exhaust vent 132, valve 134, exhaust air mover 136, and baffle 162 may be collectively referred to as infiltration/exfiltration system. In different embodiments, different numbers and locations of the exhaust vents, valves, exhaust air movers, and baffles may be used.

Incoming flow 1 (flow infiltration of a dry make-up air) may be brought into the dryer through an opening 138. In some embodiments, opening 138 may include a valve (e.g., a controllable valve) for regulating the incoming flow 1. In other embodiments, the incoming flow 1 may be regulated at least in part by a size of the opening 138 through, for example, additional cover, baffle, flow damper, or valve 139.

In some embodiments, operation of the exhaust air mover 136, valve 134, valve 139, recirculating fans 122, 124, and/or heat exchanger 142 is controlled by a controller 152. A non-limiting example of such controller is a proportional, integral, differential (PID) controller. In operation, the controller 152 may be receiving input data from one or more of temperature sensor 172, humidity sensor 174, air velocity sensor 178 and pressure sensor 176. These sensors are illustrated as one of each in FIGS. 5A and 5B, however, in different embodiments, different types of sensors may be used, and multiple quantities may be distributed through the thermal processing apparatus (e.g., dryer). Furthermore, more than one controller 152 may be used. In at least some embodiments, moisture that is introduced by the work products is removed at the same volume rate as is being given off by the work products, therefore preserving stable operations of the thermal processing apparatus 200.

In some spiral stack conveyor configurations, a fan system is used to direct the flow of thermal processing medium in the form of 100% steam or air or a mixture of steam and air vertically through the layers of spiral stacking belt. In some embodiments, the exhaust air mover 136 and/or the exhaust vent 132 may be equipped with a mass-meter, that may be useful when steam is being injected into the process to maintain higher humidity of the thermal processing medium. Steam content may be controlled through exhaust valve 134 or a another, dedicated steam valve (not shown). The steam rate would play a part in use of the exfiltration fan rotation per minute (RPM) to determine food product yield loss.

Controller 152 may control air movers, valves, heat exchangers, etc. to maintain one or more set points for temperature, moisture content, velocity of air, etc. Time, temperature, humidity and convection velocity are control variables which can be controlled to a set point via PID control within thermal processing apparatus (also referred to as an enclosed chambers climate system).

Within the food industry there are industrial processes operating at less than 212° F. with drying or steaming, as well as cooking processes at greater than 250° F., which may be varied by recipe up to 500° F. With the inventive technology disclosed herein, drying combined with cooking in conveyors enables processing modes of, for example, drying, steaming or roasting.

Some thermal processing apparatuses operate from 212° F. to 250° F. temperature range. Dryers, such as for pepperoni, operate well below 212° F. for fermentation reasons. Most other cooking occurs above 250° F. However, some work products require both cooking and drying with a set point in the 212° F. to 250° F. temperature range and humidity level controlled to a low set point in the 0 to 20% MV range. Such a relatively low humidity set point may be required for creating a consistent and high enough product evaporation rate within a set time period.

The disclosed embodiments modulate dry makeup air entry (infiltration) induced by varying exhaust vent fan 136 speed (exfiltration). High fan speed lowers humidity and lowering fan speed increases humidity. So, by modulating exhaust fan 136 speed according to sensed humidity, the chamber can be held to a set humidity. In some embodiments, a constant conveyor holding time, temperature and process zone convection velocity, each having PID controllers, is controlled to set points. Process values of time, temperature, humidity and velocity can be held constant to create the desired outcomes of exact food product moisture content and end point cook temperature that by recipe has both a dried and cooked outcome.

Additionally, control of the infiltration/exfiltration flow may have a dual utility use for (1) achieving the low humidity within the cooking and drying conditions as described above, and (2), if used in an oven, roasting in the heat mode at elevated temperatures. The above-described control of the infiltration/exfiltration flow can create oven containment and control humidity that is significantly more precise than typical oven cooking/roasting applications.

The current oven design ranges from steaming to heating with limited ability to set to a low humidity due to moisture given off by the food product and the current vent configuration limitations. By using the above-described control of the infiltration/exfiltration flow, the inventive ovens can have wider processing range from drying to roasting. Such improved apparatus provides a bridge between a dryer and cooking oven and offers expanded range of humidity setpoint in heat settings that are, for example, above 212° F. up through 500° F.

Additionally, the spatial arrangement of the components (e.g., exhaust vent 132) enables a strategic removal of moisture, in just the correct amounts (based on the controller 152) in concert with a drying curve of a specific food process. In some embodiments, controlling the speed of the recirculation fans 122, 124 further improves the induction of the air/vapor mixture at or close to the inlet of the exhaust fan 132.

Furthermore, conventional ovens can be retrofitted to embody the advantages of inventive moisture containment features. These features extend range of the settable humidity to cover an expanded breath of applications within the confines of conventional oven chamber architecture.

In some embodiments, when the work pieces are cooked and not dried, the conveyor tunnels may be held at near zero infiltration via sensed differential of, say any of pressure, temperature or humidity. Under such scenarios, the exfiltration fan may be running very slowly to satisfy only the product water evaporation loss and to exfiltrate at a very low flow rate that varies based on amount of product inside the housing. In many embodiments, this approach should result in using less electrical energy than the current ventilation arrangement. For example, with steam injection for cooking/roasting humidity such an oven may be less wasteful with respect to the steam usage given that the conveyor openings are held neutral in infiltration flow. Furthermore, when thermal oil or other heat source is used for dry heat, inventive oven becomes less wasteful.

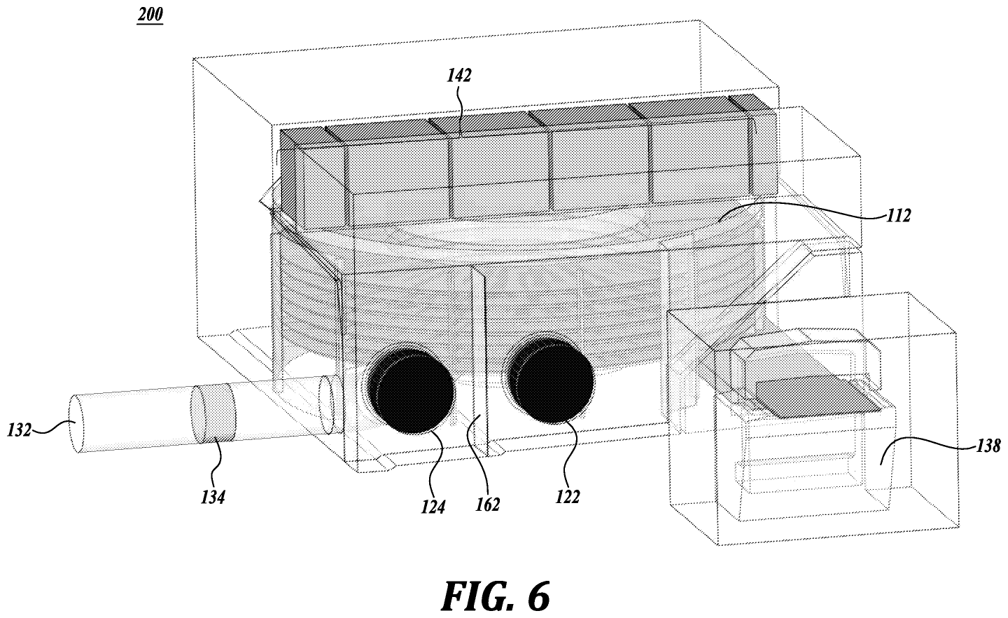

FIG. 6 is an isometric view of a thermal processing apparatus of the present disclosure. In particular, the illustrated isometric view is used as an input for a computational fluid dynamics (CFD) modeling of the fluid/thermal processes within the thermal processing apparatus 200. The model captures thermal apparatus 200 with heat exchangers 142, fans 122 and 124, inlet opening 138, belt sections and exhaust vent 132. In the illustrated embodiment, the exhaust valve 134 is modeled as a flow resistance block. The heat exchanger 142 is modeled as a flow/thermal block. In some embodiments, such representations reduce a need for modeling fine geometries of the heat exchanger piping or other fine objects, therefore simplifying the numerical model.

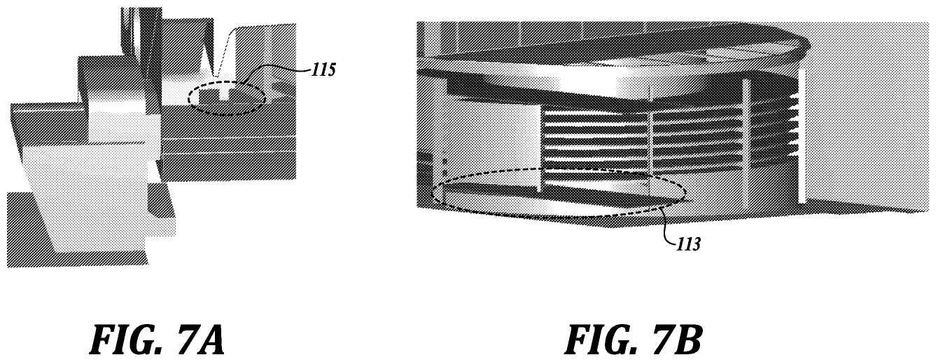

FIGS. 7A and 7B show details of the thermal processing apparatus of FIG. 6. In particular, FIG. 7A shows a window opening 115 in a baffle plate 113 of FIG. 7B. Window opening 115 in the baffle plate 113 provides a more direct path to the fan inlet for the infiltration air flow. This is advantageous as the infiltration of room air has a direct path to the inlets of fans 122, 124 where the room air is mixed in the wheel and directed into the pressure plenum. Next, the mixed gases get pushed by the fans 122, 124 through the heat exchanger. Upon leaving the heat exchanger 142, gases flow to the product zone 112. After flowing through the product zone 112, infiltration flow plus water vapor coming off the food products is partially exfiltrated through the exhaust vent 132. In some embodiments, the exfiltration flow is controlled by the exhaust valve 134 and the exhaust air mover 136. In absence of the window opening 115, room air would have to find a longer “U” shaped path around the baffle to arrive to the product zone 112. In consequence, the room temperature infiltration air would have unduly cooled the product on its way to the fans 122, 124, which negatively affects the process.

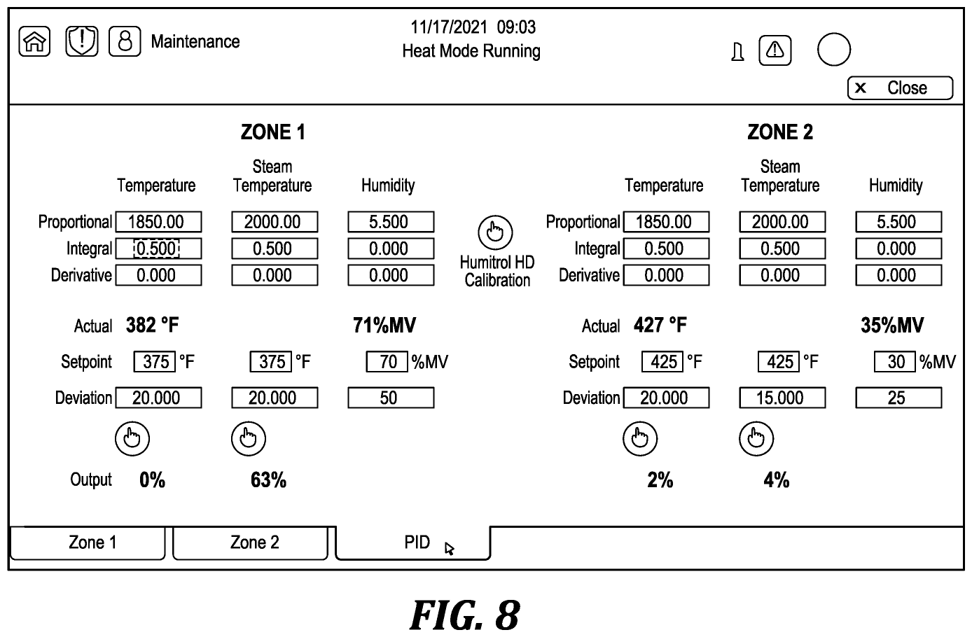

FIG. 8 shows controls of a thermal processing apparatus of the present disclosure. In some embodiments, a proportional-integral-differential (PID) controller 152 can control food drying process. In other embodiments, other controllers may be used. For example, separate setpoints for temperature and moisture volume (MV) can be established for Zone 1 (spiral processor 1) and Zone 2 (spiral processor 2). In the illustrated non-limiting example, Zone 1 has a temperature setpoint of 375° F. and MV setpoint of 70%, while the actual temperature is 382° F. and actual MV is 71% (both within the allowed deviation). Zone 2 has a temperature setpoint of 425° F. and MV setpoint of 30%, while the actual temperature is 427° F. and actual MV is 30% (also both within the allowed deviation). Maintenance of these set point is at least in part predicated on the inventive combination of fans 122 and 124, exhaust vent 132, exhaust valve 134, exhaust air mover 136, opening 138 and controllable valve 139, which, collectively, assure that the process parameters are kept within the target bounds.

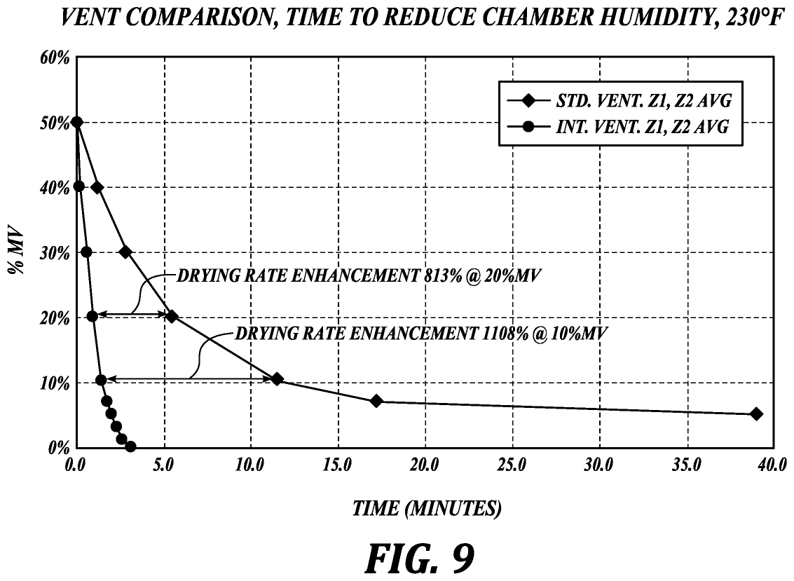

FIG. 9 shows a graph of moisture volume (MV) on a vertical axis as a function of time on a horizontal axis for a thermal processing apparatus of the present disclosure. Two cases are illustrated and compared: Std. Vent. (Standard Vent) is the conventional vent design which currently exists on the prior art ovens. Such vent is located external to the main chamber. As a result, the conventional vent tends to exfiltrate air from the conveyor path tunnel away from the main chamber.

The Int. Vent. (internal vent) case illustrates an embodiment of the inventive technology where the vent 132 exfiltrates air from the main oven chamber. The inventive technology demonstrates significantly faster process. For example, reaching the 20% MV threshold is achieved 813% faster than the conventional technology, and reaching the 10% MV threshold is achieved 1108% faster than the conventional technology. In the illustrated embodiments, the entire drying process can be finished in less than 5 minutes. Such improvements are at least in part attributable to placing the inlet of the exhaust duct 132 inside the thermal apparatus at point of high humidity levels, therefore improving the dry-out function of the inventive system.

While illustrative embodiments have been illustrated and described, it will be appreciated that various changes can be made therein without departing from the spirit and scope of the invention.

What is claimed is:

1. A thermal processing apparatus for work products, comprising:
a housing;
a powered spiral conveyor belt configured for supporting the work products during thermal processing, the conveyor belt moving along a spiral path arranged as a tiered stack;
a recirculation system configured for directing a thermal processing medium through the tiers of the spiral conveyor in a recirculating flow;
an exhaust vent having an inlet proximate to an area of a high moisture content inside the housing, the exhaust vent being configured for exfiltrating the thermal processing medium having the high moisture content; and
an opening configured for infiltrating the thermal processing medium from outside of the housing.

2. The thermal processing apparatus of claim 1, wherein the work products are subjected to drying.

3. The thermal processing apparatus of claim 1, wherein the recirculation system includes one or more fans configured to flow the thermal processing medium.

4. The thermal processing apparatus of claim 1, further comprising an exhaust air mover configured for exfiltrating the thermal processing medium through the exhaust vent.

5. The thermal processing apparatus of claim 4, further comprising:
at least one sensor selected from a group consisting of a temperature sensor, a humidity sensor, a pressure sensor, and a velocity sensor; and
a controller having an input operatively coupled with the at least one sensor, and having an output operatively coupled with the exhaust air mover,
wherein the controller is configured to regulate operation of the exhaust air mover based on the input received from the at least one sensor.

6. The thermal processing apparatus of claim 5, wherein the opening is equipped with an intake valve for regulating an infiltration of the thermal processing medium from the outside of the housing, and wherein the controller is configured to regulate opening and closing of the intake valve.

7. The thermal processing apparatus of claim 5, further comprising an exhaust valve configured within the exhaust vent, wherein the controller is configured for regulating opening and closing of the exhaust valve.

8. The thermal processing apparatus of claim 1, further comprising a baffle configured for separating flows of the thermal processing medium inside the thermal processing apparatus.

9. The thermal processing apparatus of claim 1, further comprising a heat exchanger configured to add heat to the recirculating flow.

10. The thermal processing apparatus of claim 9, further comprising a plenum configured to direct the recirculating flow toward the heat exchanger.

11. A method for thermally processing work products, comprising:
moving a powered conveyor belt along a spiral path arranged as a tiered stack inside a thermal processing apparatus, wherein the conveyor belt is configured for supporting the work products during thermal processing;
flowing a thermal processing medium as a recirculating flow through tiers of a spiral conveyor inside a housing;
exfiltrating the thermal processing medium having a high moisture content through an exhaust vent having an inlet proximate to an area of the high moisture content inside the housing; and
infiltrating the thermal processing medium from outside of the housing through an opening configured in the housing.

12. The method of claim 11, wherein the exhaust vent comprises an exhaust air mover.

13. The method of claim 12, wherein the exhaust air mover is a fan.

14. The method of claim 12, further comprising:
regulating operation of the exhaust air mover based on an input received from at least one sensor selected from a group consisting of a temperature sensor, a humidity sensor, a pressure sensor, and a velocity sensor,
wherein an input of a controller is operatively coupled with the at least one sensor, and an output is operatively coupled with the exhaust air mover, and
wherein an output of the controller is operatively coupled to the exhaust air mover.

15. The method of claim 14, wherein the opening is equipped with an intake valve for regulating an infiltration of the thermal processing medium from the outside of the housing, the method further comprising:
regulating operation of the intake valve by the controller.

16. The method of claim 12, wherein an exhaust valve is configured within the exhaust vent, the method further comprising:
regulating operation of the exhaust valve by the controller.

17. The method of claim 16, wherein the exhaust valve is a butterfly valve.

18. The method of claim 11, further comprising separating flows of the thermal processing medium inside the thermal processing apparatus by a baffle.

19. The method of claim 11, further comprising:
directing the recirculating flow through a plenum configured to direct the recirculating flow toward a heat exchanger.

20. The method of claim 19, further comprising:
adding heat to the recirculating flow by the heat exchanger.

21. The method of claim 11, wherein the work products are food items.

22. The method of claim 11, wherein the work products are subjected to drying, the method further comprising:
controlling thermal processing medium to less than 20% moisture by volume (% MV) during operation.

23. The method of claim 11, wherein the work products are subjected to drying, the method further comprising:
controlling thermal processing medium to less than 5% moisture by volume (% MV) during operation.

24. The method of claim 11, wherein the work products are subjected to drying, the method further comprising:
controlling thermal processing medium to less than 3% moisture by volume (% MV) during operation.

25. The method of claim 11, wherein the work products are subjected to cooking, the method further comprising:
controlling thermal processing medium to greater than 20% moisture by volume (% MV) during operation.
